(19) United States
(12) Patent Application Publication
(10) Pub. No.: US 2005/0263025 A1
(43) Pub. Date: Dec. 1, 2005

(54) Micro-contact printing method

(75) Inventor: Martin Hillebrand Blees, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., NL- 5621 BA Eindhoven (NL)

(21) Appl. No.: 10/521,856

(22) PCT Filed: Jul. 10, 2003
(86) PCT No.: PCT/IB03/03060

§ 371 Date: Jan. 21, 2005

(30) Foreign Application Priority Data
Jul. 26, 2002 (EP) 02078073.0

(51) Int. Cl. B41F 1/16

(52) U.S. Cl. 101/492

(57) ABSTRACT

The invention relates to micro-contact printing, wherein a self-assembled monolayer(SAM)-forming molecular species (1) is applied to a surface (2) of an article (3). The SAM-forming species (1) comprise a polar functional group that is exposed when the species (1) form a monolayer. This enables said printing method to be performed in vacuum or in a gaseous atnosphere, preferably in air. The invention also relates to an article having a surface comprising at least one isolated region of a SAM having a lateral dimension within the range of from 1 to 100 nm. Furthermore, the invention relates to a method for producing at least one nanowire, or a grid of nanowires, having a lateral dimension within the range of from 1 to 100 nm.

### The present invention relates to a method of applying a self-assembled monolayer of a molecular species to a surface of an article.

The invention also relates to an article having a surface comprising at least one isolated region of a self-assembled monolayer of a molecular species.

Furthermore, the invention relates to a method for producing at least one nanowire, or a grid of nanowires.

In the manufacturing of microelectronic and optical devices, the transferring of a pattern in the micro and/or nano scale regions to a surface of an article made of a conducting, insulating or semi-conducting material is a crucial process. Such a process should be controllable, and conveniently and inexpensively reproducible with a relatively low failure rate.

A well-known technique for transferring a pattern to an article is photolithography. A negative or positive photoresist is first coated onto the surface of the article. The resist is then irradiated in accordance with a predetermined pattern and irradiated (positive resist) or non-irradiated (negative resist) resist portions are washed away from the surface to give a predetermined pattern of resist on the surface. The resist may then serve as a mask in an etching process wherein the surface of the article that is not covered by the resist is etched, and after removal of the resist, a predetermined pattern of non-etched conducting, insulating or semi-conducting material is obtained on the surface of the article.

However, photolithography requires relatively advanced and expensive apparatus and is also relatively time-consuming.

Another method for transferring a pattern to an article is micro-contact printing. There are two main printing principles known in the art, and several variants thereof, involving micro-contact printing.

The first printing principle, herein referred to as “standard printing”, comprises pressing two sheets against each other, said two sheets contacting each other through a plane. In a variant of this printing principle use is made of a stamp for transferring a pattern from a stamping surface (first “sheet”) to an article surface (second “sheet”). A modification of the stamping process is, for instance, a printing method wherein a slightly curved stamping surface is used. Another example is a printing method wherein parts of a flexible stamping surface contact the article surface sequentially.

The second printing principle, herein referred to as “roll printing”, comprises rolling of a cylinder along a sheet, wherein the cylinder and the sheet contact each other along a line.

However, other micro-contact printing principles, or variants and modifications thereof, are also possible.

WO 96/29629 describes a printing process wherein a self-assembled molecular monolayer is formed on a surface of an article using micro-contact printing.

Self-assembled monolayers (SAMs) are typically formed of molecules having a functional group that selectively attaches (chemisorbs) to a particular surface. The remaining part of the molecule interacts with neighboring molecules to form a relatively ordered monolayer.

A method disclosed in WO 96/29629 for applying a self-assembled monolayer of a molecular species to a surface of an article comprises coating a portion of a stamping surface of a stamp with a self-assembled monolayer-forming molecular species, and transferring from the stamping surface to a first portion of the article surface the molecular species, while applying to a second portion of the article surface contiguous with the first portion a species that is not compatible with the molecular species. The stamp is maintained in contact with the article surface for a time sufficient to allow the self-assembled monolayer-forming molecular species to spread evenly from the first portion of the article surface to the second portion of the article surface. The spreading time is controlled in such a way as to provide non-coated gaps on the surface having a desirable dimension, such as from 100 nm to 10 μm. After removal of the stamp, an etchant is applied to the surface. The etchant chosen is one that does not affect the self-assembled monolayer-forming molecular species. Thus, the etchant dissolves the surface material defined by said non-coated gaps on the article surface, and after removal of the self-assembled monolayer, a pattern of non-etched material is provided on the article surface.

If the molecular species is lipophilic (i.e. hydrophobic), the incompatible Ispecies is hydrophilic. Furthermore, the incompatible species selected is one that does not chemisorb to the article surface.

Typically, the molecular species is a hydrophobic liquid, such as a molecular species having a hydrophobic long-chain alkyl group, or is carried in a hydrophobic liquid, and the incompatible species then is a hydrophilic liquid, such as water. Application of the incompatible species is necessary according to WO 96/29629 to obtain the desirable smooth and well-defined spreading of the molecular species over the article surface. Thus, if no incompatible species is present, the self-assembled monolayer-forming molecular species is said not to spontaneously spread and chemisorb between adjacent regions of stamping surface.

A typical process used in micro-contact printing today is described in Example 2 in WO 96/29629. In this example, a gold coated silicon substrate is put into a petri dish half-filled with water and a stamp including hexadecanethiol is brought into contact with the gold surface. The stamp and the substrate are either taken out of the water while still in contact and are then separated, or the stamp is separated from the gold coated substrate while still under water. The non-coated gold surface is thereafter etched using a cyanide solution.

An important drawback of this method is that the stamp must be totally immersed in water because otherwise a monolayer forms at the surface of the water which leads to complete deposition on the entire article surface at the moment it is withdrawn from the water. To avoid such a deposition, the water may, as disclosed in Example 2 in WO 96/29629, be replaced with several volumes of clean water while the article surface is still under water. However, this is a cumbersome procedure and there is still a risk that residual SAM-forming species deposit on the article surface during withdrawal from the water.

As can be easily understood from the above, this micro-contact printing under water is not an industrially suitable process. Thus, there is a need to develop a more convenient process which may be used on an industrial scale.

An object of the present invention is to alleviate the above problems, and to provide a micro-contact printing method which does not need to be performed in a liquid incompatible with the self-assembled monolayer-forming molecular species.

According to a first aspect of the invention, this and other objects are achieved with a method of applying a self-assembled monolayer of a molecular species to a surface of an article, comprising:
providing on at least a portion of a stamping surface of a stamp a self-assembled monolayer-forming molecular species having a first functional group selected to attach to said surface, and a second functional group that is exposed when the species form a monolayer, said second group being polar,
transferring the molecular species from the stamping surface to a first portion of the article surface, and
allowing the molecular species to spread evenly from the first portion of the article surface to a second portion of the article surface, wherein the spreading is accomplished with the stamp and the article is placed in a vacuum or in a gaseous atmosphere, preferably in air.

According to a second aspect of the invention, this and other objects are achieved with a method of applying self-assembled monolayers of two molecular species to a surface of an article, comprising:
providing on at least a portion of a stamping surface of a stamp a first self-assembled monolayer-forming molecular species having a first functional group selected to attach to said surface, and a second functional group that is exposed when the species form a monolayer, said second group being polar,
transferring the molecular species from the stamping surface to a first portion of the article surface,
providing on at least a portion of a stamping surface of a stamp a second self-assembled monolayer-forming molecular species having a first functional group selected to attach to said surface, and a second functional group that is exposed when the species form a monolayer, said second group being non-polar or polar, preferably non-polar,
transferring the molecular species from the stamping surface to said first portion of the article's surface coated with a monolayer of said first molecular species,
allowing the second molecular species to spread evenly over the first monolayer to a second portion of the article surface. The spreading is preferably accomplished with the stamp and the article is placed in a vacuum or in a gaseous atmosphere, more preferably in air.

An advantage of the micro-contact printing methods according to the invention is that the printing may be performed in a gaseous atmosphere, such as air. Thus, the stamp and the article do not need to be immersed in a liquid, such as water. Hence, the method according to the invention is performed much more easily than any prior art method for micro-contact printing.

An additional advantage of the methods according to the invention is that an improved controllability is provided. The amount of spreading is controlled by, for instance, temperature, contact time between stamp surface and article surface, choice of self-assembled monolayer-forming molecular species, and concentration thereof.

Still another advantage of the method according to the second aspect of the invention is that a SAM having a lateral dimension ≦100 nm is obtainable.

Thus, according to a third aspect of the invention, an article having a surface comprising at least one isolated region of a self-assembled monolayer of a molecular species is provided, wherein said region has a lateral dimension within the range of from 1 to 100 nm.

An advantage of the article according to the invention is that it may be used to produce a device, such as a microelectronic device, comprising an article surface having a very fine pattern of conducting, semi-conducting and/or insulating material(s). The applied monolayer herein can be a functional layer, but can alternatively be a layer of photoresist.

A particularly preferred example of such a very fine pattern is a channel between a source and a drain electrode in a field effect transistor. The width of the channel, which is the smallest dimension in the pattern, determines the switching speed of a transistor. With the method of the invention, this width can be reduced, and thus the transistor speed can be increased. The transistor can be a metal-oxide-semiconductor transistor on a semiconductor substrate, but is preferably a thin film transistor, that may be part of a display device. In such a thin film transistor, various techniques can be used to apply the layers, from a solution and by vapor deposition. It is preferred that printing techniques are used therefore, particularly for large and flexible substrates.

Alternatively, very fine, nanometer-scaled patterns may be used for defining nanoscaled structures.

In a preferred example, the pattern is provided on a substrate surface, the substrate comprising a stack of a first patterned layer of electrically conductive material defining a first and a second electrode and a second layer of semiconductor material. The stack may comprise any adhesion improving layer between the first and the second layer. The layer of semiconductor material is then patterned in accordance with a desired pattern with the method of the invention followed by an etching step wherein the monolayer acts as a photomask. In order to prevent underetching of the semiconductor material, it is preferably chosen to be very thin, in the order of 5-10 nm. The desired pattern here preferably comprises wire-shaped patterns, which extend from the first electrode to the second electrode. Combined with a gate dielectric and a gate electrode, that can be provided on top of the semiconductor material, or as part of the substrate, a transistor is obtained comprising a nanowire semiconductor. As described in the non-prepublished application EP02076428.8 (PHNL020286), the nanowire may contain parts with a larger width, that can be used for memory or opto electronic purposes.

Furthermore, according to a fourth aspect of the invention a method for producing at least one nanowire, or a grid of nanowires, is provided. This method according to the invention comprises:
providing on a surface layer of a first material at least one region of a self-assembled within the range of from 1 to 100 nm, said surface layer being applied on a second layer of a second material,
applying on the surface layer an etchant selected as one that removes unprotected first material, but leaves the SAM and the protected first material underlying said at least one region of SAM unaffected,
applying an etchant selected as one that removes essentially the entire second layer, and
isolating said first material, with or without said SAM, forming at least one nanowire, or a grid of nanowires, having a lateral dimension within the range of from 1 to 100 nm. The nanowire can be made of a conducting, semi-conducting or isolating material.

At least one region of a self-assembled monolayer (SAM) of a molecular species is preferably provided on the surface layer of the first material by using the above disclosed method according to the second aspect of the present invention.

### Other features and advantages of the present invention will become apparent from the embodiments described hereinafter and the appended claims.

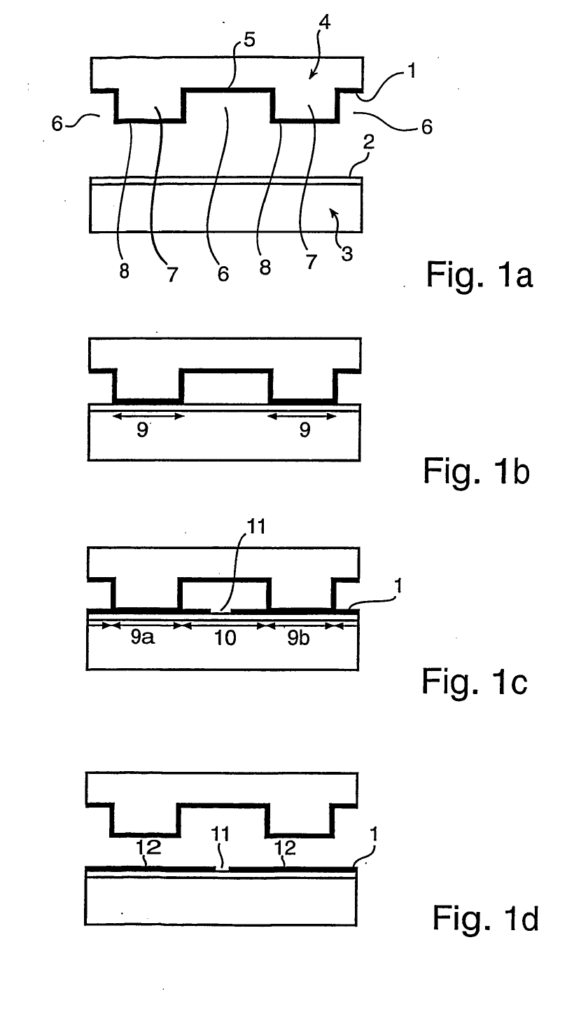

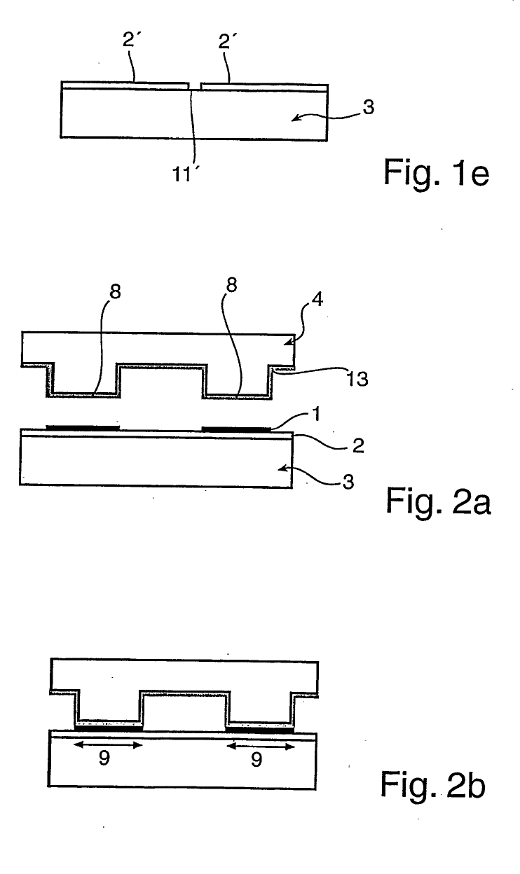

FIG. 1 schematically shows an embodiment of the method for applying a SAM according to the invention.

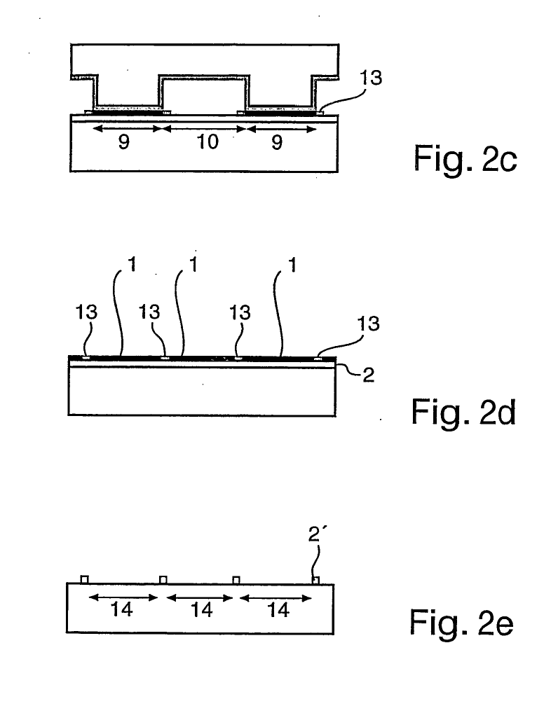

FIG. 2 schematically shows an embodiment of the method for applying two SAMs according to the invention.

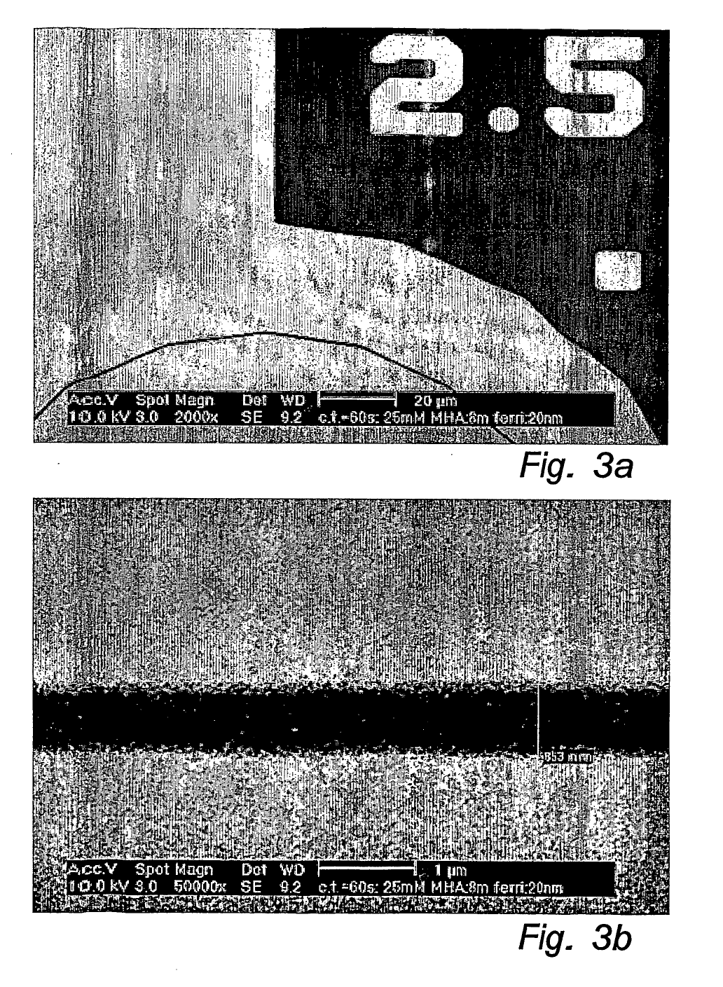

FIG. 3 shows a SEM graph of a ring transistor produced by applying a SAM according to an embodiment of the invention.

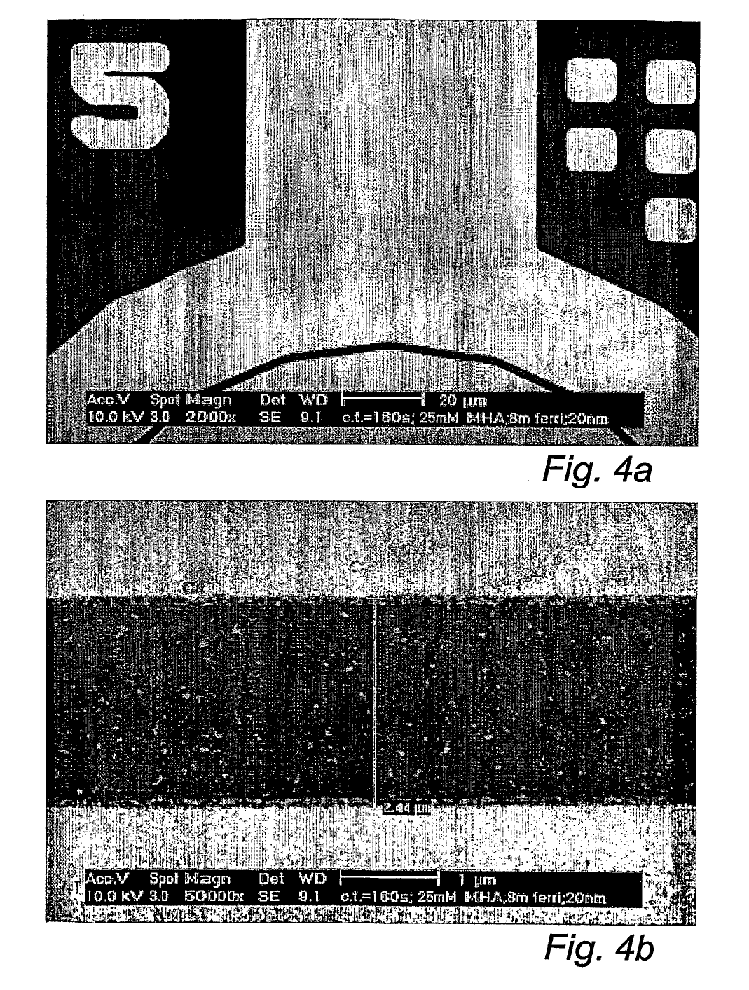

FIG. 4 shows a SEM graph of a ring transistor produced by applying a SAM according to an embodiment of the invention.

FIGS. 1a-e schematically shows a first embodiment of a micro-contact printing method according to the invention for applying a self-assembled monolayer of a molecular species 1 to a surface 2 of an article 3.

The surface 2 of the article 3 preferably consists of a surface layer 2 of a material other than the material constituting the article 3.

For instance, the article 3 might be a silicon substrate coated with a surface layer 2 of gold.

A stamp 4 having a surface 5 is used in said method. The surface 5 preferably has a plurality of indentations 6 that form an indentation pattern, and define a plurality of protrusions 7, which outwardly facing surfaces form a stamping surface 8.

Firstly, the stamping surface 8, typically the entire surface 5, is provided with a self-assembled monolayer-forming molecular species 1 having a polar functional group (see FIG. 1a) that is exposed when the species form a monolayer.

The SAM-forming species 1 may be provided on the stamping surface 8 (or the entire surface 5) by (a) directly coating the surface 8 with the species 1; (b) bringing the stamping surface 8 into contact with an “ink pad” comprising the species 1; (c) providing the species 1 in the interior of the stamp and allowing the species 1 to diffuse through the stamp until it reaches the stamping surface 8, or (d) any other application method known in the art, see, for instance, Libioulle, L; Bietsch, A; Schmid, H; Michel, B; Delamarche, E; Langmuir, 15(2), p 300-304 (1999), and Blees et al, US 20020073861 A1.

The stamping surface 8 is thereafter brought into contact with a first portion 9 of the article surface 2 and the molecular species 1 is transferred from the stamping surface 8 to said first portion 9 of the surface 2 (see FIG. 1b).

While stamping surface 8 and the first portion 9 of the article surface 2 are still in contact, the molecular species 1 is allowed to spread evenly from the first portion 9 to a second portion 10 of the article surface 2, see FIG. 1c. This spreading is accomplished with the stamp 4 and the article 3 placed in a gaseous atmosphere, preferably air. Thus, it is not necessary to apply a species not compatible with the self-assembled mono-layer forming molecular species 1, e.g. water, as disclosed in WO 96/29629.

The stamp 4 and the article 3 may also be placed in a vacuum or in a reduced pressure atmosphere.

SAM-forming molecular species 1 are usually of the general formula R′-A-R″, wherein R′ is a functional group selected to attach to an article surface of a certain material, A is a spacer, and R″ is a functional group that is exposed when the species form a SAM. Thus, R″ defines the functionality of the SAM. For instance, if the exposed functional group R″ is hydrophilic, the SAM displays a hydrophilic exposed surface.

SAM-forming molecular species 1 may, however, also have the generalized structure R′-A-R″-A′-R′, wherein A′ is a second spacer or the same as A, or R′-A-R″-A′-R′″, wherein R′″ is the same or a different exposed functionality as R″. Additionally, species such as R′-A-R″-B and B-R′″-A′-R′-A-R′″-B′ may be chosen, wherein B and B′ are similar to A, do not prevent exposure of R′″ and R″ to the surrounding environment, and may be the same or different. It is to be understood that, in the above general formulas, A and R″ or R′″ may not be distinguishable, but may be continuous. For example, when A comprises an alkyl chain, and R″ or R′″ comprises an alkyl functionality, A and R″ or R′″ together may simply define an alkyl chain.

The article surface 2 can be made from a variety of electrically conducting, insulating or semi-conducting materials.

The choice of the functional group R′, which is supposed to attach to the article's surface 2, depends on the material of the article surface 2.

A non-limiting exemplary list of suitable materials for the article surface 2 and preferred functional groups which chemisorb thereto are given below.

Sulphur-containing functional groups such as thiols, sulphides, disulphides, and the like firmly attach to metals, such as gold, silver, copper, cadmium, zinc, palladium, platinum, mercury, lead, iron, chromium, manganese, tungsten, and alloys thereof

Silanes and chlorosilanes firmly attach to doped or undoped silicon, quartz, glass, and oxide surfaces, such as chromium oxide, titanium oxide, indium oxide, and tin oxide.

Carboxylic acids firmly attach to metal oxides, such as silica, aluminia, and other oxide surfaces, such as chromium oxide, titanium oxide, indium oxide, and tin oxide, quartz, glass, and the like.

Nitriles and isonitriles firmly attach to platinum and palladium.

Hydroxarnic acids firmly attach to copper.

Other functional groups include acid chlorides, anhydrides, sulfonyl groups, phosphoryl groups, hydroxyl groups and amino acid groups.

Other materials for the article surface include germanium, gallium, arsenic, gallium arsenide, epoxy compounds, polysulfone compounds, and other polymeric materials.

The SAM-forming molecular species 1 used in the method according to the present invention could comprise any functional group selected to attach to a certain surface material. Hence, the method according to the invention is suitable for any surface material as long as a SAM-forming species 1 may be attached thereto.

The important thing for the SAM-forming molecular species 1 used in the present method is that the exposed functional group (R″ and/or R′″) is polar.

As used herein the term “polar functional group” means any functional group having a more polar character than —CH₃. Such a polar group may also be referred to as hydrophilic or lipophobic.

A non-limiting exemplary list of suitable polar groups which may be used in the method according to the invention is the following: —OH, —CONH, —CONHCO, —NCO, —NH₂, —NH—, —COOH, —COOR, —CSNH—, —NO₂, —SO₂⁻—, —COR, —COX, —ROR, —RCOR, —RCSR—, —RSR—, —PO₄²⁻, —OSO₃⁻—, —SO₃⁻—, NHₓR₄₋ₓ, —COO⁻, —SOO⁻, —RSOR—, —CONR₂, —(OCH₂CH₂)ₙOR (where n=1−100), —PO₃H⁻, -2-imidazole, —N(CH₃)₂, —NR₂, —PO₃H₂, —CN, —SH, a halogenated hydrocarbon, or any chemically possible combination of these groups.

In the above list, R is hydrogen or an organic group, such as a hydrocarbon or a halogenated hydrocarbon.

As used herein the term “hydrocarbon” includes alkyl, alkenyl, alkynyl, cycloalkyl, aryl, alkaryl, aralkyl, and the like. The hydrocarbon group may for example comprise methyl, propenyl, ethynyl, cyclohexyl, phenyl, tolyl, and benzyl groups. As used herein the term “halogenated hydrocarbon” means halogenated derivates of the above described hydrocarbons.

R may also be a biologically active species, such as an antigen, an antibody, or a protein, as known to persons skilled in the art. Thus, a SAM which selectively binds to various biological or other chemical species can be provided. For instance, if R in the SAM-forming species is an antibody, the corresponding antigen may be selectively bound to a surface coated with the SAM-forming species.

X is a halogen atom, such as Cl, F, or Br.

Preferred polar groups which may be used in the method according to the invention are the following:
—OH, —NCO, —NH₂, —COOH, —NO₂, —COH, —COCl, —PO₄²⁻, —OSO₃⁻, —SO₃⁻, —CONH₂, —(OCH₂CH₂)ₙOH, —(OCH₂CH₂)ₙOCH₃ (where n=1−100), —PO₃H⁻, —CN, —SH, —CH₂I, —CH₂Cl, and —CH₂Br.

The most studied combination of Surface material and SAM-forming species 1 is a gold surface 2 and SAM-forming molecular species 1 comprising a sulphur-containing group, such as a thiol group.

The SAM-forming molecular species 1 used in the method according to the present invention is preferably selected from the group consisting of:
an omega-functionalized thiol having the general formula R′-A-R″, wherein R′ is —SH, A is —(CHR)ₙ— where R is H or —CH₃, and n is an integer from 1 to 30, preferably from 12 to 30, more preferably from 16 to 20, and R″is a polar group,
a disulphide having the general formula R′″-A-S-S-A′-R″, wherein R″ is a polar or a non-polar group, A and A′ independently are —(CHR)ₙ— where R is H or —CH₃, and n is an integer from 1 to 30, preferably from 12 to 30, more preferably from 16 to 20, and R″ is a polar group different from or the same as R′″, and
a thioether having the general formula R′″-A-S-A″-R″ or R′″-A-S-A′-S-A″-R″, wherein R′″ is a polar or a non-polar group, A, A′, and A″ independently are —(CHR)ₙ— where R is H or —CH₃, and n is an integer from 1 to 30, preferably from 12 to 30, more preferably from 16 to 20, and R″ is a polar group different from or the same as R′″.

The sulphur-containing groups, such as —SH, attach to the article's surface, and R″ is an exposed functional group of the SAM-forming molecular species.

More preferably, the SAM-forming molecular species used in the method according to the present invention is an omega-functionalized thiol.

Referring now to FIG. 1c, the first portion 9 of the article's surface 2 preferably comprises at least two isolated regions 9a and 9b separated by the second portion 10. Thus, the molecular species 1 is preferably transferred from the stamping surface 8 to the at least two isolated regions 9a and 9b of the first portion 9, and then allowed to spread from each of the at least two isolated regions 9a and 9b of the first portion 9 toward each other. The stamping surface 8 and the first portion 9 of the article's surface 2 preferably remain in contact for a time sufficient to provide a gap 11 having a predetermined dimension between the spreading molecular species 1.

The width of the gap 11 is preferably within the range of from 50 nm to 5 μm, more preferably from 100 nm to 2 μm.

The obtained width of the gap 11 depends on several factors affecting the spreading process, which factors may be controlled.

Firstly, the time during which the stamping surface 8 is in contact with said first portion 9 of the article surface 2 affects the amount of spreading.

Secondly, the concentration of the SAM-forming molecular species 1 affects the amount of spreading. A higher concentration results in faster spreading.

Thirdly, the temperature at which said spreading is performed affects the amount of spreading. A higher temperature results in faster spreading.

Fourthly, the type of SAM-forming molecular species 1 selected affects the amount of spreading.

Fifthly, the flux (diffusion rate) of the SAM-forming molecular species 1 to the stamping surface 8 also affects the amount of spreading. For instance, if the SAM-forming species 1 is provided in the interior of the stamp 4, the flux will depend on the diffusion coefficient and the concentration of species 1 in the stamp 4. The diffusion coefficient of the SAM-forming species 1 is affected by the size and shape of the molecular species 1 and by the interaction between the SAM-forming species 1 and the stamp material, generally rubber. Thus, the spreading may, to some extent, be controlled by selection of suitable stamp material(s) or any other modification of the stamp 4 as known in the art. For instance, a diffusion barrier, e.g. a thin film of a metal, a polymer, a ceramic, or a hybrid organic-inorganic material, may be incorporated in the stamp 4 to control the flux of the SAM-forming species 1. This diffusion barrier may be provided anywhere in the path of diffusion of the SAM-forming species 1 within the stamp 4.

The size of the indentions 6 and protrusions 7 of the stamp 4 may also have some minor effect on the amount of spreading.

The relationship between surface tension (surface energy) (γ) and contact angle (Θ) for a liquid (L) droplet on a solid (S) substrate surface in a gaseous (G) atmosphere, such as air, is expressed by Young's law:
γ_{SG}=γ_{SL}+γ_{LG} cos Θ (I)

γ_{SG} denotes the surface tension between the substrate surface and air, γ_{SL} denotes the surface tension between the solid surface and the droplet, and γ_{LG} denotes the surface tension between the droplet and air.

Spreading occurs when Θ≈0, thus
γ_{SG}<γ_{SL}+γ_{LG} (II)

During said spreading, unattached SAM-forming species diffuse over the monolayer. The diffusion of these non-attached molecular species on the monolayer is, on a molecular scale, quite similar to the behavior of a liquid droplet on a substrate surface. Thus, Young's law is, at least approximately, applicable to describe the spreading process.

The surface tension between the monolayer and air corresponds to γ_{SG} in Young's law.

The surface tension between the diffusing unattached SAM-forming species and the monolayer corresponds to γ_{SL} in Young's law.

The surface tension between the diffusing unattached SAM-forming species and air corresponds to γ_{LG} in Young's law.

For a gold surface in air, γ_{SG}>500 mJ/m².

A monolayer of the omega-functionalized thiol comprising a non-polar methyl group, HS—(CH₂)₁₇—CH₃, in air gives γ_{SG} of about 20 mJ/m².

A monolayer of the omega-functionalized thiol comprising a polar carboxylic acid group, HS—(CH₂)₁₅—COOH, in air gives γ_{SG} of about 50 mJ/m².

Thus, the above thiol comprising a non-polar exposed functional group will not spread on its own monolayer, i.e. the thiol is described as autophobic, because γ_{SG} is relatively low.

However, the above thiol comprising a polar exposed functional group will spread on its own monolayer because γ_{SG} is relatively high.

Referring now to FIG. 1d, as the desirable gap width has been obtained, the stamp 4 is removed from the article surface 2, and an article 3 having a surface 2 comprising at least one area 12, preferably a plurality of areas 12, coated with SAMs 1 is obtained, said areas 12 being separated by a small gap 11.

After removal of the stamp 4, an etchant is applied to the article's surface 2. The etchant selected does not affect the SAM-forming molecular species 1, but etches the material used for the article surface 2, e.g. gold. Thus, the surface material defined by the gap 11 on the article surface 2 is removed by the etchant and the areas 12 coated with SAM are left undisturbed.

After the etching process, the SAM 1 is either removed, resulting in a patterned article surface 2 having protruding areas 2′ of surface material separated by an etched area 11′ corresponding in size to said gap 11 (see FIG. 1e), or the SAM 1 is kept on the article surface 2′, for instance, to act as an adhesion promoter during application of an additional layer thereon or because it may actually have a favorable effect on the function of the resulting device comprising the article.

Delamarche et al, J Am Chem Soc, 124, p 3835 (2002) describes a method of producing an article surface having an inversed pattern in relation to the above. The method comprises the application of a second SAM-forming species to non-coated areas of an article surface that is partially coated, by micro-contact printing, with a first SAM-forming species. The SAM-forming species are selected in such a way that the only the first SAM is affected by a certain etchant, and the second SAM is not.

The above disclosed method according to the invention may be used to provide such an inversed pattern.

Alternatively, instead of etching, selective deposition using e.g. electroless deposition, electrodeposition, particle/polymer adsorption from solution, surface-initiated polymerization, or chemical vapor deposition, may be performed using the partially SAM-coated article surface obtained by the method according to the present invention.

FIGS. 2a-e schematically shows parts of a second embodiment of a micro-contact printing method according to the invention. All of the steps disclosed above, and shown in FIGS. 1a-d, up to the removal of the stamp 4 are performed. In FIG. 2a, no spreading of SAM-forming species 1 is shown to have occurred. However, it might, for reasons indicated below, be advantageous to allow some spreading to occur.

After removal of the stamp 4, the stamp 4 is cleaned by removing any residual SAM-forming species 1 and a second SAM-forming molecular species 13 having preferably a non-polar functional group is provided, by any of the methods disclosed above, on the stamping surface 8, see FIG. 2a.

Instead of cleaning the stamp 4, a second stamp having either a stamping surface identical to the one used for transfer of the first molecular species 1, or a stamping surface with a different pattern and/or dimensions than the first stamp may be used.

Subsequently the stamping surface 8 is again brought into contact with the first portion 9 of the article surface 2 coated with the first SAM-forming species 1, see FIG. 2b. If an identical stamping surface 8 is used for transfer of both SAM-forming species 1 and 13, it might, due to reasons of alignment, be advantageous to allow some spreading of molecular species 1 to occur before application of the second SAM-forming species 13.

The molecular species 13 cannot chemisorb to the first portion 9 of the article surface 2 since the first SAM-forming species 1 is already attached thereto. However, the second SAM-forming species 13 will diffuse over the first SAM 1 until it reaches the second uncoated portion 10 of the article surface 2, see FIG. 2c. As soon as a few molecules of this second SAM-forming species 13 attach to the article surface 2 and form a second SAM 13, the diffusion will stop because the SAM-forming species 13 having a non-polar exposed functional group is autophobic, i.e. the molecules will not spread on their own monolayer. Thus, this strips of the second SAM-forming species 13 having very small lateral dimensions, such as within the range of from 1 to 40 nm, are provided.

Thus, an article 3 having a surface 2 comprising at least one isolated region of a self-assembled monolayer of a molecular species 13 is provided, wherein said region having a lateral dimension within the range of from 1 to 40 nm.

The first molecular species 1 is then again applied and attached to the remaining uncoated article surface 2, see FIG. 2d. The first molecular species 1 may be applied by dip coating, vapor deposition, spraying, or by transfer using a flat stamp without indentations or protrusions.

An etchant, selected as one that removes the first SAM-forming species 1 and etches the underlying material of the article surface 2, but that does not disturb the second SAM-forming species 13, is applied to the article surface 2. After the etching process the second SAM 13 is, if so desired, removed, resulting in a patterned article surface 2 having protruding areas 2′ of surface material separated by etched areas 14, see FIG. 2e.

An example of the first SAM-forming molecular species 1 is pentaerythritol-tetrakis (3-mercaptopropion-ate).

An example of the second SAM-forming molecular species 13 is 1-octadecylthiol.

In a third embodiment of the present invention, the above second SAM-forming molecular species 13 comprises a polar second functional group. Thus, such a molecular species is not autophobic, which means that the molecules will spread on their own monolayer and provide SAM-strips with a larger lateral dimension, such as within the range of from 40 to 100 nm, or even larger, than in the second embodiment disclosed above.

Thus, an article 3 having a surface 2 comprising at least one isolated region of a self-assembled monolayer of a molecular species 13 is provided, said region having a lateral dimension within the range of from 40 to 100 nm.

The present invention also relates to a method for producing at least one nanowire, or a grid of nanowires, of conducting, semi-conducting or insulating material. The above disclosed article having a surface 2 comprising at least one isolated region of a self-assembled monolayer of a molecular species 13, said region having a lateral dimension within the range of from 1 to 100 nm, is preferably utilized in this method

Thus, in an embodiment of this method according to the invention, an article comprising a surface layer of a first material and at least one second layer of a second material located underneath the surface layer is utilized in the above disclosed method according to the second aspect of the invention. After the above disclosed removal of the first SAM-forming species 1 and the underlying surface layer material (first material), a second etchant, selected as one that removes the second material constituting the entire second layer, including the areas located under the second SAM 13, is applied. As the second layer is removed by the second etchant at least one isolated nanowire, or an isolated grid of nanowires, of non-etched surface material, e.g. gold, possibly still coated with the second SAM-forming species 13, is separated from the article. The second SAM-forming species 13, if still present, is subsequently removed from the nanowire or the grid or is kept if so desired. Thus, at least one nanowire, or a grid of nanowires, having a lateral dimension within the range of from 1 to 100 nm is provided.

As used herein, the term “nanowire” is not restricted to wires having a symmetric cross-section. It might just as well be a wire having, for instance, an essentially rectangular cross-section. Such a wire might also be referred to as a “nanoribbon”.

Examples of devices comprising such nanowires, or a grid of nanowires, are field emitters, wire grid polarizers, and microelectronic devices.

The micro-contact printing methods according to the invention may be performed using any known printing principle, such as standard printing, roll printing or variants thereof, as disclosed in the introduction.

The method according to the present invention is useful for the production of, for example, electronic devices, such as transistors, biosensors, liquid crystalline displays, optical devices, or any other articles comprising a surface (curved or non-curved) having a micro-structured pattern.

The invention will now be further elucidated by means of the following non-limiting examples, which show that the distance of diffusion of a SAM-forming species, applied according to the method of the present invention, increases with contact time between the stamping surface and the article surface.

### EXAMPLE 1

An omega-functionalized thiol comprising a polar carboxylic acid group, HS—(CH₂)₁₃—COOH, was dissolved in ethanol, yielding a thiol concentration of 25 mM.

Other organic solvents, such as methanol, 2-butanone, acetone, 1-propanol, 2-propanol toluene, o-xylene, p-xylene, tetrahydrofyran, or dimethylformamide, may also be used. However, ethanol is the preferred solvent.

A stamp having a stamping surface defined by the outward-facing surfaces of several protrusions was provided with the dissolved thiol.

The distance between the protrusions studied in this example was 2.5 μm and the height of the protrusions perpendicular to the stamping surface was 2.1 μm. The protrusions corresponded in size to the source and drain electrodes of a transistor structure.

A layer of titanium (Ti) having a thickness of 5 nm and, on top thereof, a layer of gold (Au) having a thickness of 20 nm were sequentially applied using thermal evaporation on a silicon substrate coated with a thermal oxide having a thickness of 200 nm. The titanium layer here acts as an adhesive between the gold and the oxide. Other substances, such as chromium (Cr), molybdenum (Mo), titanium-tungsten (TiW), may also be used as an adhesion layer.

Said thiol was transferred from the stamping surface to a first portion of the gold-coated silicon substrate using the method disclosed above and shown in FIGS. 1a-e, thereby forming a self-assembled monolayer on the gold surface. The first portion of the gold surface consists of several isolated regions separated by a second portion of the gold surface.

The stamping surface and the gold surface were in contact for 60 s before removal of the stamp. During this period of time, the thiol spread from each isolated region towards the adjacent region, creating a gap width, herein also referred to as the source-drain distance, of about 0.85 μm between the spread thiols. Thus, the thiols diffused about 0.8 μm during the contact period of 60 s.

The temperature during the contact period was 23° C.

The resulting substrate having a partially SAM-coated gold surface was then immersed in an aqueous solution containing 1.0 M KOH, 0.1 M K₂S₂O₃, 0.01 M K₃Fe(CN)₆, and 0.001 M K₄Fe(CN)₆ for 8 minutes at 23° C. This etchant removes the uncoated gold surface defined by the gap, but does not affect the thiol, thus leaving the areas coated with the thiol non-etched.

The titanium layer was revealed in the area where gold was removed. The titanium in this area was subsequently removed by immersing the substrate in an aqueous solution containing 1.5 M H₂O₂ and 1.0 M (NH₄)₂HPO₄ at 40° C.

After these etching processes, the thiol was removed by placing the substrate in a microwave plasma reactor in an argon atmosphere at a pressure of 0.25 mbar for 1 minute, thus providing a patterned gold surface having protruding areas of gold separated by etched areas with a lateral dimension of about 850 nm.

A SEM graph of a ring (shaped) transistor produced according to this Example is shown in FIG. 3. The outer ring therein defines the drain electrode and the inner ring defines the source electrode. The channel is present between the source and the drain electrode. Semiconductor material, gate dielectric and gate electrode are not shown, but can be applied in known manner. The semiconductor material is for instance amorphous silicon or an organic semiconductor or it is provided as nanowires of semiconductor material.

It shall be noted that the switching frequency of a transistor decreases quadratically with the source-drain distance.

### EXAMPLE 2

Example 1 was repeated with the exceptions that the contact time was 160 s, and that the distance between the protrusions studied in this Example was 5.0 μm.

The gap provided had a width (source-drain distance) of about 2.4 μm. Thus, the thiols diffused about 1.3 μm during the contact period of 160 s.

A SEM graph of a ring transistor produced according to this Example is shown in FIG. 4.

While the invention has been described in detail and with reference to specific embodiments thereof, it will be apparent to persons skilled in the art that various changes and modifications can be made therein without departing from the spirit and scope thereof.

1. A method of applying a self-assembled monolayer of a molecular species to a surface of an article, comprising:
providing on at least a portion of a stamping surface of a stamp a self-assembled monolayer-forming molecular species having a first functional group selected to attach to said surface, and a second functional group that is exposed when the species form a monolayer, said second group being polar,
transferring the molecular species from the stamping surface to a first portion of the article surface, and
allowing the molecular species to spread evenly from the first portion of the article surface to a second portion of the article surface, characterized in that the spreading is accomplished with the stamp and the article is placed in a vacuum or in a gaseous atmosphere.

2. A method of applying self-assembled monolayers of two molecular species to a surface of an article, comprising:
providing on at least a portion of a stamping surface of a stamp a first self-assembled monolayer-forming molecular species having a first functional group selected to attach to said surface, and a second functional group that is exposed when the species form a monolayer, said second group being polar,
transferring the molecular species from the stamping surface to a first portion of the article surface, characterized by
providing on at least a portion of a stamping surface of a stamp a second self-assembled monolayer-forming molecular species having a first functional group selected to attach to said surface, and a second functional group that is exposed when the species form a monolayer, said second group being polar or non-polar,
transferring the molecular species from the stamping surface to said first portion of the article surface coated with a monolayer of said first molecular species, and
allowing the second molecular species to spread evenly over the first monolayer to a second portion of the article's surface.

3. A method according to claim 2, wherein the spreading is accomplished with the stamp and the article is placed in a vacuum or in a gaseous atmosphere.

4. A method according to claim 3, wherein the second functional group of the second self-assembled monolayer-forming molecular species is non-polar.

5. A method according to claim 1, wherein the gaseous atmosphere is air.

6. A method according to claim 1, wherein the article′ surface is a metal surface and the self-assembled monolayer-forming molecular species is selected from the group consisting of:
an omega-functionalized thiol having the general formula R′-A-R″, wherein R′ is —SH, A is —(CHR)ₙ— where R is H or —CH₃, and n is an integer from 1 to 30, and R″ is a polar group,
a disulphide having the general formula R′″-A-S-S-A′-R″, wherein R′″ is a polar or a non-polar group, A and A′ independently are —(CHR)ₙ— where R is H or —CH₃, and n is an integer from 1 to 30, and R″ is a polar group, different from or the same as R′″, and
a thioether having the general formula R′″-A-S-A″-R″ or R′″-A-S-A′-S-A″-R″, wherein R′″ is a polar or a non-polar group, A, A′, and A″ independently are —(CHR)ₙ— where R is H or —CH₃, and n is an integer from 1 to 30, and R″ is a polar group, being different from or the same as R′″.

7. A method according to claim 6, wherein the polar group R″ is a functional group selected from the group consisting of —OH, —NCO, —NH₂, —COOH, —NO₂, —COH, —COCl, —PO₄²⁻, —OSO₃⁻, —SO₃⁻, —CONH₂, —(OCH₂CH₂)ₙOH, —(OCH₂CH₂)ₙOCH₃, —PO₃H⁻, —CN, —SH, —CH₂I, —CH₂Cl, and —CH₂Br, wherein n is an integer from 1 to 100.

8. An article having a surface comprising at least one isolated region of a self-assembled monolayer of a molecular species, characterized in that said region has a lateral dimension within the range of from 1 to 100 nm.

9. A method of producing at least one nanowire, or a grid of nanowires, characterized in that the method comprises:
providing a surface with a second layer of a second material and providing a surface layer of a first material thereon,
providing on the surface layer at least one region of a self-assembled monolayer (SAM) of a molecular species, said region having a lateral dimension within the range of from 1 to 100 nm,
applying on the surface layer an etchant selected as one that removes unprotected first material, but leaves the SAM and the protected first material underlying said at least one region of SAM unaffected,
applying an etchant selected as one that removes essentially the entire second layer, and
isolating said first material, with or without said SAM, thus forming at least one nanowire or a grid of nano-wires.

10. A method of manufacturing an electronic device comprising the step of providing a patterned layer with a desired pattern on a surface of an article, characterized in that the patterned layer is defined by providing a monolayer according to claim 1.

11. A method as claimed in claim 10, characterized in that an electronic device is provided with a field effect transistor having a source and a drain electrode, a channel, a gate electrode and a gate dielectric, and that the desired pattern defines the channel between the source and the drain electrode.

12. A method as claimed in claim 10, characterized in that
the article comprises at its surface a stack of a first patterned layer of electrically conductive material and a second layer of semiconductor material, in which first layer a first and a second, mutually isolated electrode are defined;
the desired pattern is such that a perpendicular projection thereof on the first layer overlaps with the first and the second electrode;
after defining the pattern, the second layer is etched with an etchant selected as one that removes unprotected semiconductor material, but leaves the pattern and the protected semiconductor material underlying the pattern unaffected.

13. A method of manufacturing an electronic device comprising the step of providing nanowires on a substrate, characterized in that the nanowires obtainable with the method according to claim 9 are provided.
